(19) United States
(12) Patent Application Publication
(10) Pub. No.: US 2014/0360329 A1
(43) Pub. Date: Dec. 11, 2014

(54) PAPER MATERIAL CUTTING MECHANISM WITH ANVIL MEANS

(71) Applicant: Tzu-Che LIN, Taoyuan County (TW)

(72) Inventor: Tzu-Che LIN, Taoyuan County (TW)

(21) Appl. No.: 14/258,734

(22) Filed: Apr. 22, 2014

(30) Foreign Application Priority Data
Jun. 6, 2013 (TW) 102210657

(51) Int. Cl. B26D 5/20; B26D 1/00

(52) U.S. Cl. CPC B26D 5/20; B26D 1/0006; B26D 2001/0046
USPC 83/206

(57) ABSTRACT

A paper material cutting mechanism includes a cutter unit including a material conveyor rack having a cutting slot, a cutter holder mounted below the material conveyor rack, a circular cutter rotatably mounted at the cutter holder and a driver controllable to move the cutter holder to carry the circular cutter into the cutting slot or away from cutting slot, and an anvil unit disposed above the cutter holder of the cutter unit and including a pivoted bracket, anvil wheels pivotally mounted at the bracket and a driver adapted for moving the pivoted bracket to carry the anvil wheels between an operative position in proximity to the material conveyor rack around the cutting slot and a non-operative position far from the material conveyor rack.

This application claims the priority benefit of Taiwan patent application number 102210657, filed on Jun. 6, 2013.

### BACKGROUND OF THE INVENTION

1. Field of the Invention

The present invention relates to paper product manufacturing technology and more particularly, to a paper cutting mechanism, which comprises a cutter unit controllable to move a circular cutter into a cutting slot for cutting a paper material being delivered by a material conveyer rack, and an anvil unit controllable to move anvil wheels into contact with the paper material during a cutting operation of the circular cutter or away from the paper material after each cutting operation of the circular cutter.

2. Description of the Related Art

Wooden cases, cartons and paper boxes are widely used for storing or packing commercial products. However, wooden cases are commonly heavy and expensive, not convenient for delivery. Further, nails are commonly used for packaging wooden boxes. Cartons and paper boxes have the advantages of light weight and low cost. Further, cartons and paper boxes can be packaged with a glue, hot melt adhesive or adhesive tape, facilitating packing. Packaging a product in a carton or paper box can effectively protect the product against impact damage and facilitate the delivery or storage of the product. Therefore, cartons and paper boxes are widely used for packing lightweight products.

Further, the fabrication of a corrugated paper or cardboard requires a series of processing steps including splicing, pre-heating, shaping, gluing, cooling, liner laminating, trimming, cutting, stacking, and etc. Further, during the fabrication of cartons or paper boxes, corrugated or cardboard sheet materials must be properly cut subject to the desired sizes. FIG. 4 illustrates a prior art paper cutting mechanism for this purpose. As illustrated, the paper cutting mechanism comprises a conveyor unit A for delivering a paper sheet material B to pass between a vertically movable cutter wheel C and a wheel brush D, enabling the paper sheet material B to be supported on brush bristles D1 of the wheel brush D and cut by the cutting edge C1 around the cutter body C2 of the cutter wheel C. Subject to the functioning of the wheel brush D to support the moving paper sheet material B, the cutter wheel C can cut off the paper sheet material B accurately, However, this prior art design of paper cutting mechanism still has drawbacks as outlined hereinafter.

1. When the cutter wheel C is lowered to cut the paper sheet material B, it will also cut into the brush bristles D1 of the wheel brush D, causing the brush bristles D1 to be damaged or cut off, and shortening the service life of the wheel brush D.

2. When cutting the paper sheet material B, the cutter wheel C is lowered, however the position of the wheel brush D remains unchanged. Because the distance between the wheel brush D and the cutter wheel C in the lower limit position and the elevational position of the wheel brush D are not adjustable, the brush bristles Dl in the area around the wheel brush D will be frequently cut by the cutting edge C1 around the cutter body C2 of the cutter wheel C, causing the wheel brush D to wear out quickly.

Therefore, it is desirable to provide a paper material cutting mechanism, which eliminates the drawbacks of the aforesaid prior art design and has a long service life.

### SUMMARY OF THE INVENTION

The present invention has been accomplished under the circumstances in view. It is therefore the main object of the present invention to provide a paper material cutting mechanism, which allows relative movement between the cutter unit and the anvil unit thereof, preventing the cutter from cutting into the anvil wheels of the anvil unit directly and lowering the risk of anvil wheel damage.

To achieve this and other objects of the present invention, a paper material cutting mechanism of the invention comprises a cutter unit and an anvil unit. The cutter unit comprises a material conveyor rack for conveying a paper material for cutting and defining therein a cutting slot, a cutter holder mounted below the material conveyor rack, a cutter rotatably mounted at the cutter holder, and a driver pivotally coupled with the cutter holder and controllable to move the cutter holder up and down between a cutting position where the cutter is inserted into the cutting slot and a non-cutting position where the circular cutter is kept away from the cutting slot. The anvil unit is disposed above the cutter holder of the cutter unit, comprising a pivoted bracket, a plurality of anvil wheels pivotally mounted at the bracket, and a driver adapted for moving the pivoted bracket up and down to carry the anvil wheels between an operative position in proximity to the material conveyor rack around the cutting slot and a non-operative position far from the material conveyor rack.

Further, the driver of the cutter unit can be a pneumatic cylinder or hydraulic cylinder adapted for moving the cutter holder up and down. Further, the cutter of the cutter unit is a circular cutter. When the circular cutter is inserted into the cutting slot, it cuts off the moving paper material.

Further, the driver of the anvil unit can be a pneumatic cylinder or hydraulic cylinder. Further, the anvil wheels are selected from the group of wheel brushes, soft plastic wheels, rubber wheels and silicon rubber wheels. By means of moving the anvil wheels toward the cutter unit to the operative position, the anvil wheels support the moving paper material for cutting by the circular cutter of the cutter unit. As the anvil wheels and the circular cutter are movable relative to each other, the cutting dept of the circular cutter relative to the anvil wheels is controlled, preventing anvil wheel damage and prolonging the service life of the anvil wheels.

### BRIEF DESCRIPTION OF THE DRAWINGS

FIG. 1 is a schematic side view of a paper material cutting mechanism in an operation status in accordance with the present invention.

FIG. 2 corresponds to FIG. 1 when viewed from another angle.

FIG. 3 corresponds to FIG. 1, illustrating the anvil wheels of the anvil unit lowered during a paper material cutting operation.

FIG. 4 is a schematic sectional side view of a paper material cutting mechanism according to the prior art.

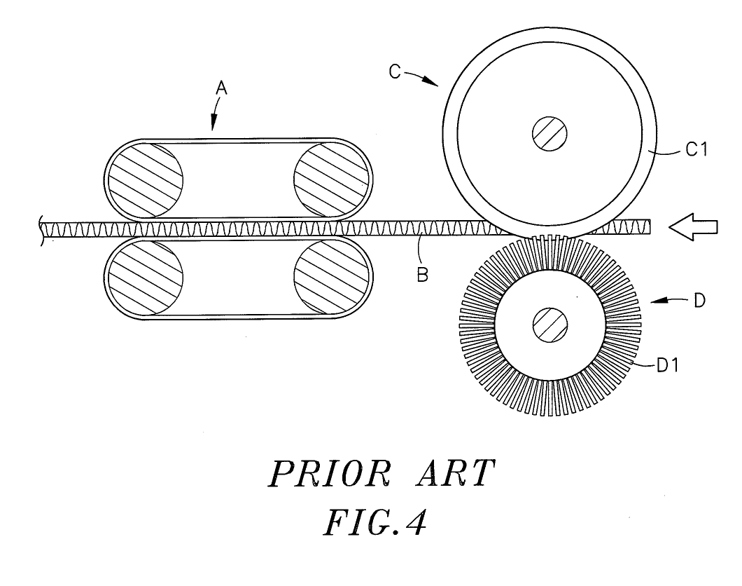

### DETAILED DESCRIPTION OF THE PREFERRED EMBODIMENT

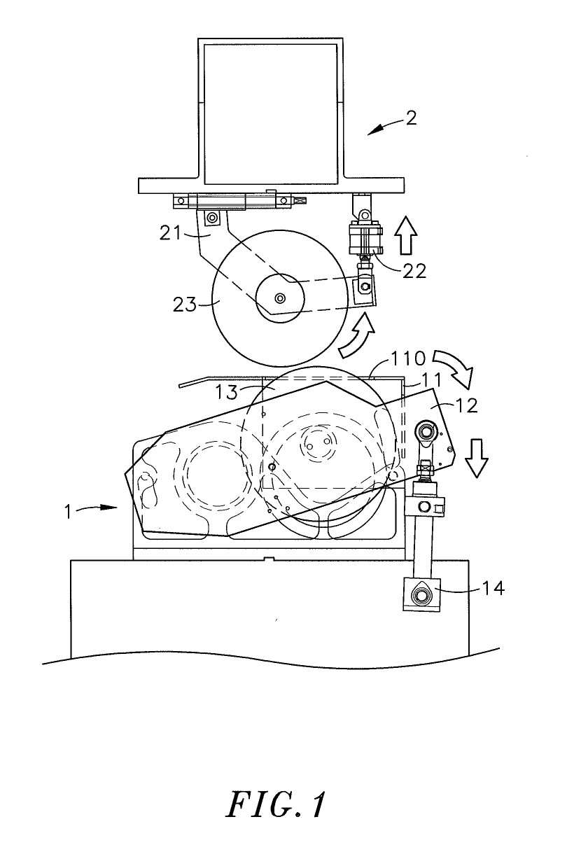

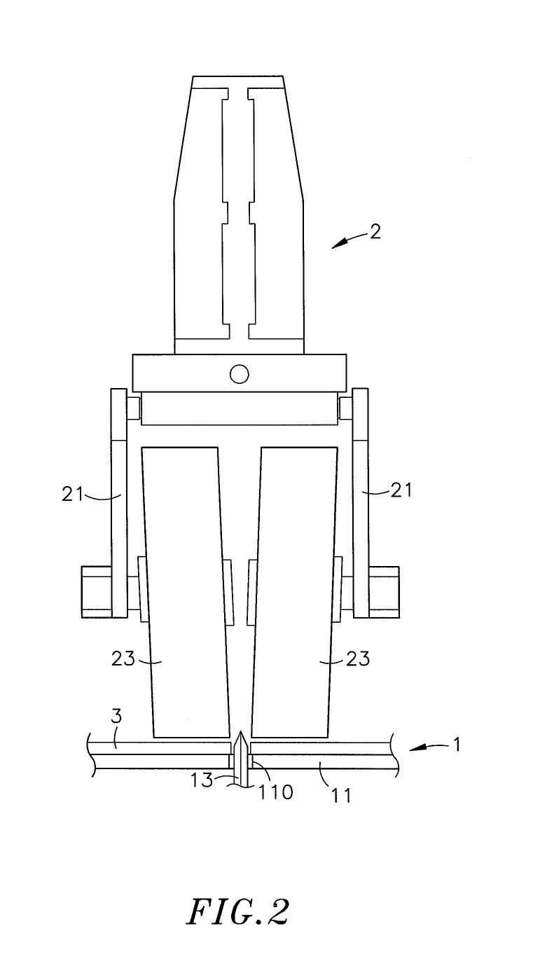

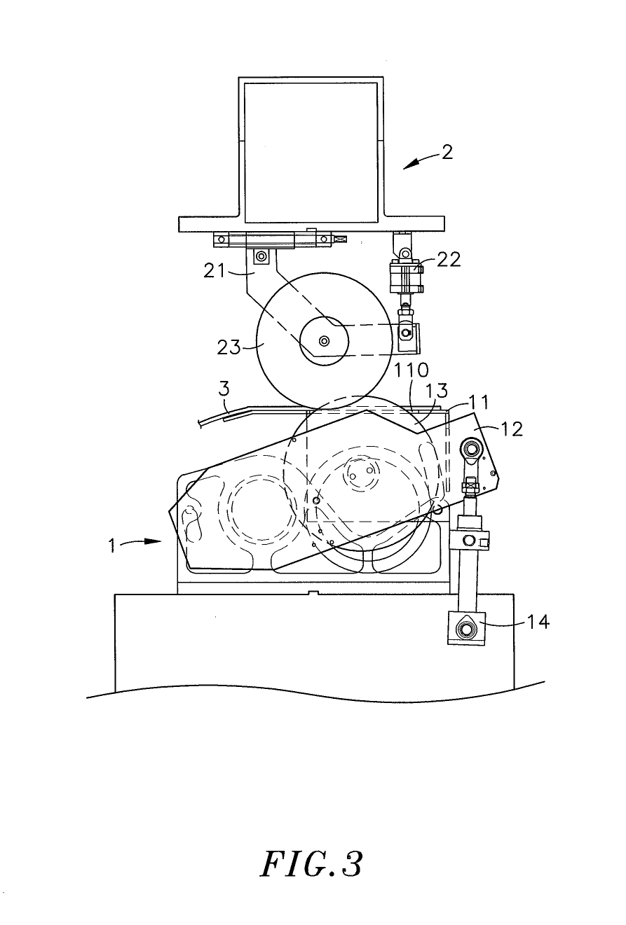

Referring to FIGS. 1-3, a paper material cutting mechanism in accordance with the present invention is shown. As illustrated, the paper material cutting mechanism comprises a cutter unit 1 and an anvil unit 2.

The cutter unit 1 comprises a material conveyor rack 11 having a cutting slot 110, a cutter holder 12 mounted below the material conveyor rack 11, a circular cutter 13 rotatably mounted at the cutter holder 12, and a driver 14 pivotally coupled with the cutter holder 12.

The anvil unit 2 comprises a substantially L-shaped bracket 21 pivotally located at one side, a driver 22 disposed opposite to the L-shaped bracket 21 and adapted for moving the L-shaped bracket 21 alternatively up and down, and at least one, for example, two anvil wheels 23 pivotally mounted at the L-shaped bracket 21.

During the installation of the paper material cutting mechanism, mount the anvil unit 2 above the cutting slot 110 of the material conveyor rack 11 of the cutter unit 1 to keep the anvil wheels 23 in alignment with the area around the cutting slot 110, and then mount the circular cutter 13 at the cutter holder 12. After installation of the paper material cutting mechanism, the driver 14 of the cutter unit 1 can be controlled to bias the cutter holder 12 in moving the circular cutter 13 toward or away from the cutting slot 110 of the material conveyor rack 11 of the cutter unit 1, and the driver 22 of the anvil unit 2 can be controlled to bias the L-shaped bracket 21 in moving the anvil wheels 23 toward or away from the cutting slot 110 of the material conveyor rack 11 of the cutter unit 1.

Further, the driver 14 of the cutter unit 1 and the driver 22 of the anvil unit 2 can be pneumatic cylinders or hydraulic cylinders respectively controlled to move the cutter holder 12 of the L-shaped bracket 21 alternatively up and down.

Further, the anvil wheels 23 at the L-shaped bracket 21 can be wheel brushes, soft plastic wheels, rubber wheels or silicon rubber wheels, or any other design of wheels made from soft materials.

During application of the present invention, a paper material 3 (corrugated paperboard or cardboard) is delivered by the material conveyor rack 11 of the cutter unit 1. When the paper material 3 is being delivered forwards, the driver 22 of the anvil unit 2 is controlled to lower the L-shaped bracket 21 in moving the anvil wheels 23 into contact with the paper material 3 around the cutting slot 110 of the material conveyor rack 11 of the cutter unit 1, and the driver 14 of the cutter unit 1 is simultaneously controlled to lift the cutter holder 12 in moving the circular cutter 13 into the cutting slot 110 of the material conveyor rack 11 of the cutter unit 1 to a predetermined depth (preferably in the range of 1 mm˜5 mm) to cut off the paper material 3 subject to the desired size.

Thus, by means of controlling the operation of the driver 14 of the cutter unit 1 and the operation of the driver 22 of the anvil unit 2, the circular cutter 13 and the anvil wheels 23 are moved to change the distance therebetween. During the operation of the circular cutter 13 to cut the moving paper material 3, the anvil wheels 23 are kept in contact with the moving paper material 3 around the cutting slot 110 of the material conveyor rack 11 of the cutter unit 1, enabling the circular cutter 13 to cut off the moving paper material 3 accurately without damaging the anvil wheels 23, and thus the service life of the anvil wheels 23 is prolonged.

As stated above, the invention provides a paper material cutting mechanism, which comprises a cutter unit 1 that comprises a material conveyor rack 11 having a cutting slot 110, a cutter holder 12 mounted below the material conveyor rack 11, a circular cutter 13 rotatably mounted at the cutter holder 12 and a driver 14 pivotally coupled with the cutter holder 12 and adapted for moving the cutter holder 12 alternatively up and down, and an anvil unit 2 that comprises a substantially L-shaped bracket 21 pivotally located at one side, two anvil wheels 23 pivotally mounted at the L-shaped bracket 21 and a driver 22 disposed opposite to the L-shaped bracket 21 and adapted for moving the L-shaped bracket 21 alternatively up and down. Thus, when controlling the driver 14 to lift the cutter holder 12 in moving the cutter holder 12 into the cutting slot 110 of the material conveyor rack 11 to cut the moving paper material 3, the L-shaped bracket 21 of the anvil unit 2 is lowered by the driver 22 to move the anvil wheels 23 in contact with the moving paper material 3 around the cutting slot 110 of the material conveyor rack 11 of the cutter unit 1, enabling the moving paper material 3 to be cut off by the circular cutter 13 accurately without causing damage to the anvil wheels 23.

In actual application of the present invention, the paper material cutting mechanism has the advantages as described hereinafter.
1. By means of controlling the operation of the driver 14 of the cutter unit 1 and the operation of the driver 22 of the anvil unit 2, the circular cutter 13 and the anvil wheels 23 are moved in direction toward or away from each other to change the distance therebetween, enabling the paper material 3 being conveyed to be cut off by the circular cutter 13 accurately without causing damage to the anvil wheels 23.
2. By means of controlling the operation of the driver 14 of the cutter unit 1 and the operation of the driver 22 of the anvil unit 2, the circular cutter 13 and the anvil wheels 23 are accurately moved in direction toward or away from each other to change the distance therebetween, and the cutting dept of the cutting operation of the circular cutter 13 is well controlled without damaging the anvil wheels 23.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A paper material cutting mechanism, comprising:
a cutter unit comprising a material conveyor rack for conveying a paper material for cutting, said material conveyor rack comprising a cutting slot, a cutter holder mounted below said material conveyor rack, a circular cutter rotatably mounted at said cutter holder, and a driver pivotally coupled with said cutter holder and controllable to move said cutter holder up and down between a cutting position where said circular cutter is inserted into said cutting slot and a non-cutting position where said circular cutter is kept away from said cutting slot; and
an anvil unit disposed above said cutter holder of said cutter unit, said anvil unit comprising a pivoted bracket, a plurality of anvil wheels pivotally mounted at said bracket, and a driver adapted for moving said pivoted bracket up and down to carry said anvil wheels between an operative position in proximity to said material conveyor rack around said cutting slot and a non-operative position far from said material conveyor rack.

2. The paper material cutting mechanism as claimed in claim 1, wherein the driver of said cutter unit is selected from the group of pneumatic cylinder and hydraulic cylinder.

3. The paper material cutting mechanism as claimed in claim 1, wherein said anvil wheels are selected from the group of wheel brushes, soft plastic wheels, rubber wheels and silicon rubber wheels; the driver of said anvil unit is selected from the group of pneumatic cylinder and hydraulic cylinder.
